(19) United States
(12) Patent Application Publication
(10) Pub. No.: US 2014/0164010 A1
(43) Pub. Date: Jun. 12, 2014

(54) System and Method for Displaying and Analyzing Data

(71) Applicant: Applied Research Works, Inc., Palo Alto, CA (US)

(72) Inventors: Shaibal Roy, Palo Alto, CA (US); Subhendu Aich, Palo Alto, CA (US); Mark Feinholz, Redwood City, CA (US); Pankaj Agarwal, Kolkata (IN)

(73) Assignee: Applied Research Works, Inc., Palo Alto, CA (US)

(21) Appl. No.: 14/092,918

(22) Filed: Nov. 27, 2013

Related U.S. Application Data
(60) Provisional application No. 61/730,487, filed on Nov. 27, 2012.

(51) Int. Cl. G06Q 50/22; G06Q 10/06

(52) U.S. Cl. CPC G06Q 50/22; G06Q 10/06
USPC 705/2

(57) ABSTRACT

Disclosed is a system and method for analyzing and displaying quantitative information in a healthcare setting. Specifically, the present disclosure teaches a method of assessing provider performance and patient compliance, both prospectively and retrospectively.

### PRIORITY CLAIM

This application claims the benefit of U.S. Provisional Application No. 61/730,487 filed on Nov. 27, 2012. The aforementioned provisional application is hereby incorporated by reference.

### BACKGROUND

Healthcare providers and provider organizations are increasingly being held to quality and performance measures that are interval-based. Typically, these measures are by third party organizations (e.g., NCQA/HEDIS, PQA, NQF, Milliman's, CMS). Often these measures are defined as “retrospective” using either calendar year intervals (e.g., two distinct outpatient visits with the CPT code of 250.xx in the current or the previous calendar year) or age (e.g., the child turn two during the current calendar). In this context, “retrospective” means after-the-fact. Current solutions analyze health histories over the past years and/or quarters to compute these measures for providers and provider organizations.

The retrospective measures, as defined above, assist the providers and provider organizations to get paid for work done in the past, but they do not help them operate looking into the future. A purely prospective (meaning looking into the future) measure will be interesting, but not very useful since typically providers and provider organizations are paid not for future potential but for past performance.

Most current implementations do not enable a prospective view that converges to an exact retrospective measure over time. There are solutions that compute exact retrospective measures. Additionally, there are solutions that identify problems and opportunities looking into the future, but, there remains a need for a solution to correlate the two sufficiently.

### BRIEF SUMMARY

Disclosed is a system and method that displays and analyzes data in a healthcare setting. Specifically, the disclosed system and method provide prospective implementation of the existing retrospective measures, where estimates of current and future performance converge to exact measures of past performance over time. This enables providers and provider organizations to measure their performance and to see how their performance will impact future reimbursements. Additionally, such a tool would enable providers to change and improve operating procedures to make tangible impact on these measures for the current and future quarters. They can see how much they will get paid current and next quarter, and where they need to act to make a difference in that payment cycle.

### BRIEF DESCRIPTION OF THE DRAWINGS

FIG. 1 illustrates an embodiment of a system.

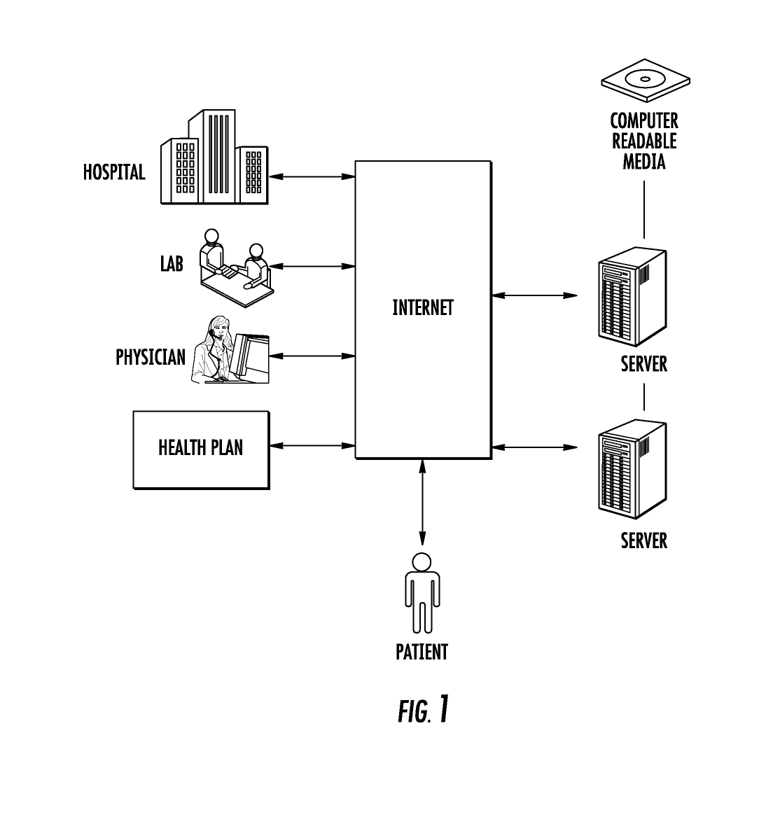

FIG. 2 illustrates an embodiment of a user interface wherein a provider can view information.

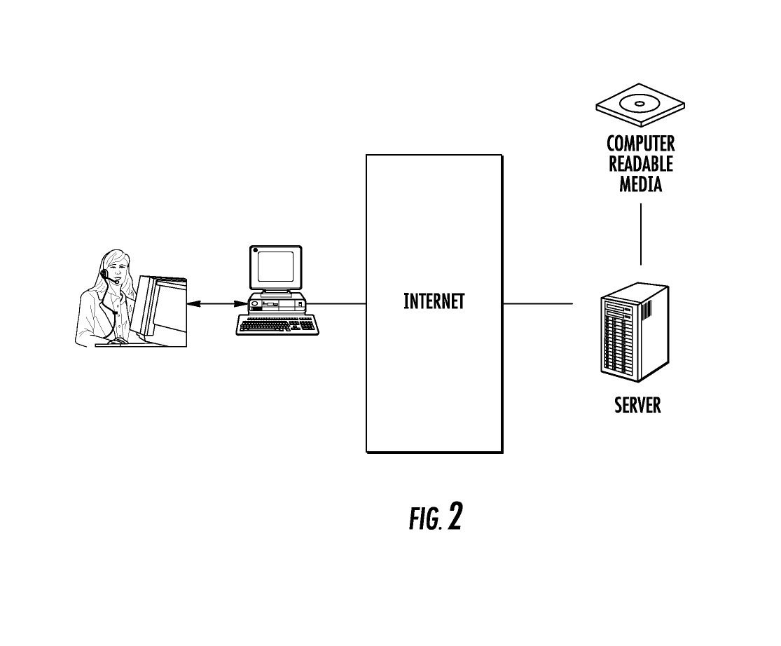

FIG. 3 illustrates an embodiment of a user interface that shows patient compliance to a provider.

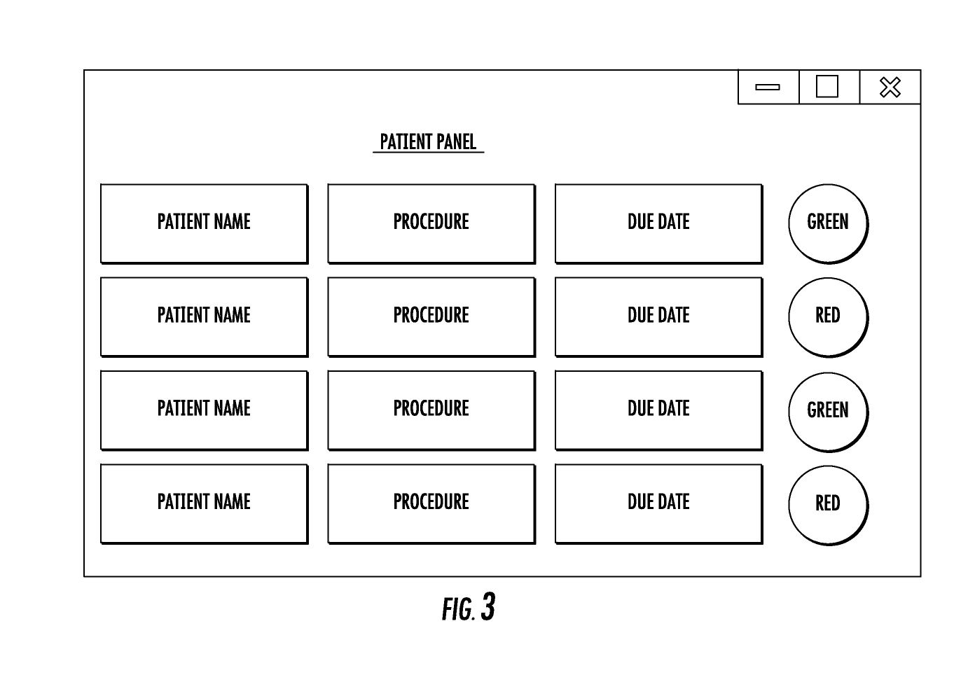

FIG. 4 illustrates an embodiment determining a compliance percentage for a given provider.

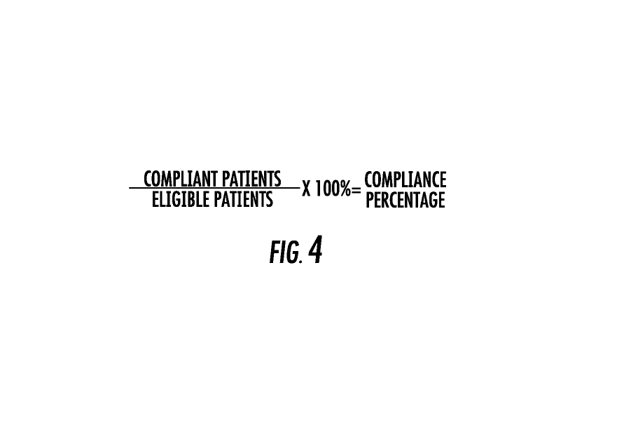

FIG. 5 illustrates an embodiment of rolling patient compliance metrics in a given provider's patient panel.

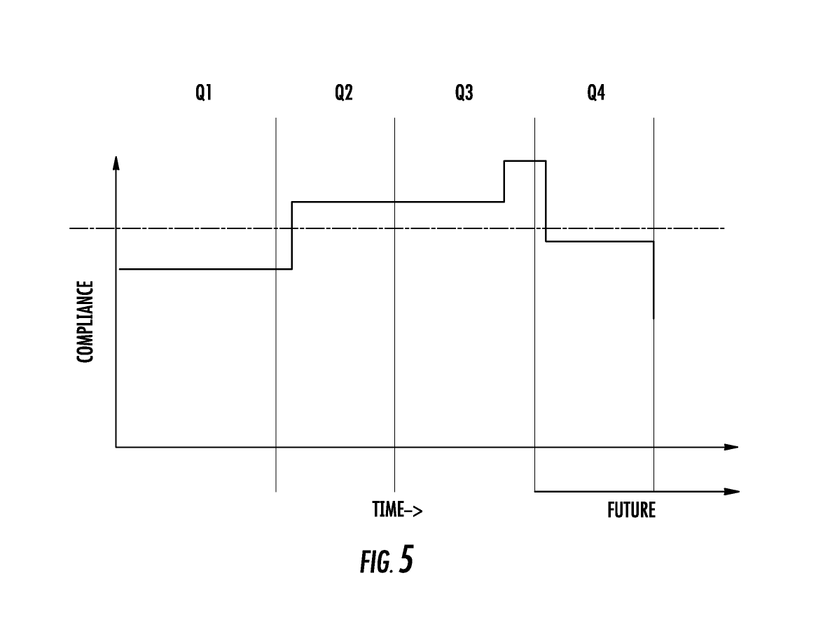

### DETAILED DESCRIPTION

Disclosed is a system and method for displaying and analyzing data in a healthcare setting. The system comprises one or more servers, each server coupled to a network. In certain embodiments, one or more servers are coupled to the Internet. In certain embodiments, non-transitory computer readable media encoding instructions for carrying out various methods is coupled to one or more server. In certain embodiments, information inputted into the system by healthcare providers, payers (including insurance companies and managed care organizations), and patients. Healthcare providers upload data into the system and receive data from the system. Data can be viewed through computers coupled to the Internet or another network. In some embodiments, data from an electronic health record is obtained by the system.

In certain embodiments, the system obtains patient panels from one or more providers. The patient panels include one or more patients treated by the provider, and information pertaining to each patient. Information pertaining to each patient may include names, health information, dates of procedures, diagnostic codes, diagnoses, dates of birth, age, place of residence, and financial information.

In many embodiments, data is analyzed in accordance with a set of inclusion criteria, exclusion criteria, and compliance criteria. Inclusion criteria will serve as a denominator. The denominator counts the number of patients in a particular disease condition or age or risk category. For example, inclusion criteria may include patients who have diabetes, or patients in need of a procedure such as a diagnostic study because of their age or an immunization because of their age or date of last immunization. Exclusion criteria are criteria that will exclude patients from the denominator. This criterion includes factors that render the standard care guidelines inappropriate or unnecessary for the patient. For example, a diabetic patient would be excluded from the denominator if the patient this patient does not need an annual HbA1C test because she has only gestational diabetes. Compliance criteria comprise the patient population whose sum will be the numerator. The numerator counts the number of patients for who proper care guideline was followed. An example of a patient population appearing in the numerator would be number of diabetic patients who were compliant in receiving annual HbA1C tests.

The quotient of the numerator to denominator is a compliance ratio. In certain embodiments, this ratio may be displayed to a provider on an electronic device. In alternative embodiments, the ratio may be displayed as a percentage.

The ratio of numerator to denominator determines the performance of the provider or provider organization over a registry whose size is the denominator. These performance measures can be evaluated over a variety of intervals—for example, over calendar years, or by “quarter years”, wherein the year is not defined as a calendar year, rather it's defined by a rolling quarter system. In such a system, a year is not defined as a traditional calendar year; rather a quarter year would be defined as the preceding 4 quarters.

One embodiment will display clinically acceptable estimated due date by spacing of remaining procedures over the measure period. In one embodiment, an immunization schedule can be displayed and compliance can be determined. This information may be obtained by taking the patient's date of birth, from health plan records or electronic health record. Secure File Transfer Protocol (or any file transfer mechanism) may be used by the system to obtain information from a health plan or Electronic Health Record. Information obtained from the Electronic Health Record may include a unique patient ID, date of birth, gender, name, or contact information. Information pertaining to medical and health history may include dates of service, drug dosage, immunizations records, procedures performed, diagnostic study results, and provider information.

In a certain embodiment, a feasible schedule is determined based on metric and clinical guidelines. This information may be displayed on a patient information page. Some embodiments may comprise a plurality of specific pages; (separate pages and separate views for patients, providers, health plans, care extenders, provider organizations). Due dates for various medical procedures or examinations are shown as a due date. Such due dates may be obtained from third party vendors or may be recognized in the healthcare field as recognized due dates for given procedures and exams. In one embodiment, if it is if feasible for a patient to comply with a suggested schedule, the system will display an icon that indicates compliance is feasible. In certain embodiments, tasks for which compliance is feasible will be shown “green” and if not feasible, shown as “red”. Red indicates a patient or provider is not in compliance, or that compliance is not possible.

Certain embodiments enable providers to look forward into the future by creating a longitudinal patient history. This data could be comprised of claims arriving from Insurance payer or health plans, electronic medical records of the patient from other providers or facilities, provider's office, clinics or practice management system [PMS]. This data arrives at present to the system by means of secure file transfer protocol [SFTP], but could alternatively use EDI X12.837 or REST/SOAP based web service API or through paper mail of medical image from the source of the data into our system.

This data then adds to the longitudinal history of the patient and resides in the system's data store, which could be flat file based system, RDBMS, or map-reduce database over proprietary computing cluster. In some embodiments, This longitudinal data of a specific patient is then analyzed across all HEDIS metrics over the queried time period to compute if the patient is eligible, compliant or excluded with respect to a particular disease metrics over a period of time. This computation strictly adheres to HEDIS guidelines. In other embodiments, guidelines and protocols other than HEDIS can be used.

The system then aggregates these compliance, eligibility and exclusion statistics over the entire population of patients and doctors, which renders the aggregate statistics useful for further analysis.

For doctor D, on disease Metrics M, out of total attributed patients for doctor D being P_{D}, the system can compute from HEDIS metrics H _{M}, over an epoch of time t₁ to t₂,

Where t₁=start date of the epoch

and t₂ =end date of the epoch

Number of compliant patients=m_{D} [where m_{D}<=P_{D}]

Number of eligible patients=n_{D} [where n_{D}<=P_{D}]

Number of excluded patients=e_{D} [where e_{D}<=P_{D}]

For all the metrics computation, as per HEDIS, the epoch of time most relevant is the measurement year, which is computed as the range of dates falling between (t₂-365) and t₂ But the period could also be customized to be a quarter, a week, a month or even a day or any other variable time interval, and not only one full measurement year.

The metric dashboard can quickly be summarized as:
compliance percentage for doctor D by disease M metric as 100*(m_{D}/n_{D})
compliance percentage for doctor over the specific epoch of time
compliance details of patients per doctor in a more detailed view

This system makes it possible to extend the end time of the queried epoch into a future date, and offer the same metrics as discussed above for that future period of time. This future view to the doctor enables him/her with the information to facilitate any preventive preemptive action on his/her behalf

To give an example of the user behavior and how the flow helps user, on 20 Sep. 2012, which falls in Q3 of 2012, a doctor can view how his aggregate performance over disease metrics would appear if he were to look into Q4,2012, which starts from 1 Oct. 2012. As soon as he chooses the drop down to point to Q4,2012, a database query from browser fetches the re-computed compliance, exclusion, eligibility values given the new time epoch. The screen refreshes with new data for individual metrics. The doctor can now track the metrics which exhibits a drop in compliance percentage by moving the calendar forward. That could instigate further probe into why this happened, and he could act in order to prevent such a drop in compliance.

Certain embodiments build a longitudinal patient history by combining histories from multiple covered entities and use it to computed population health metrics. In such embodiments, the system obtains different part of the patient P's data dp=_{{}dpₛ₁,dpₛ₂ . . . dp_{sn}} from different sources or partners {S₁S₂ . . . Sₙ} of different types and build longitudinal data for the patient by joining the set together. This source of data could be health plans, clinics, practice managements systems or providers. The system could receive this data by means of secure file transfer, through paper, over web service API or EDI transactions. This data, on arrival, is stored securely at the system data store and is used to derive insights I(Σdp) over the complete data than just an incomplete partial view that the source or partner could manage by themselves.

By combining data for a patient from several sources, the system then has more complete view of patients' longitudinal medical data, rich in semantics. For example the health plan A may have a repository of their patient data, but has no view of demographic profile of patients tied to Health Plan B. By accumulating and aggregating data from multiple sources, the system is able to provide customized global perspective on the data of an aggregated population. By aggregating this data the system can then could provide S₂ with aggregated insight over dp instead of insight over dpₛ₂ that S₂ could manage to derive by itself.

In a certain embodiment, if in State S, there are Ps patients, Ds providers, Hs number of health plan providers, Cs number of clinics, by accumulating data from all these sources and by combining them together the system can offer to provide customized of data across the spectrum of partners and providers.

Health plans have with them patient's claims data including pharmaceutical or drug claims, labs or clinics have the electronic health record of the patient, provider's offices have electronic medical records. Typically, none of them have overall view of a patient's data to have a holistic view of patient's longitudinal history. In contrast, the disclosed system provides a complete longitudinal history or a given patient, with data aggregated across numerous sources.

Providers are likely to be incentives to share information with the system in order to share in the repository of information held by the system. To give an example of this, health plan A has data for a specific patient who has disease (d). By computing a demographic profiling over similar patients of same gender and age group with a given disease, the system can provide the health plan with an aggregated insight as to if that patient may also be susceptible to other diseases, or the fact that, such patients are known to avoid certain preventive measures that is otherwise known to facilitate early treatment. This insight may lead to better care, prevention of medical emergencies, and an overall reduction of operational cost for Health Plans.

In certain embodiments, each payer can analyze data in accordance with their individually selected metrics. Metrics can differ by hospitals (e.g. readmission rates), providers (e.g. patient compliance), and pharmacies (medication adherence).

In the instance of Health Information Exchanges (HIE's), data is not sorted, rather it is just sent as raw data. This system enables participants to view data through the lenses of their pre-selected metrics, rather than raw data. In certain embodiments, Providers DO NOT have access to raw patient data. In certain embodiments, all coding data is transferred.

In certain embodiments, supplemental data is usable by multiple payers, where payers benefit from each other's data and the data from other non-payer covered-entities. Supplemental data is additional information inputted into the system by a provider or a provider's agent. In certain embodiments, supplemental data may include any information that is entered by the provider that is not data extracted from the electronic health record by the system.

In certain embodiments, providers may add a positive or negative attestation. In certain embodiments, attestation is a notation by a provider wherein a provider attributes a patient's care to a provider's practice. In some embodiments, physicians control their own data and it is shared with other health plans with their permission. In certain embodiments, physicians may also add information to a patient data set, that is not part of the medical record and not claim data.

In certain embodiments, supplemental data is usable by multiple payers, where payers benefit from each other's data and the data from other non-payer covered-entities.

In a certain embodiment, there are two ways a provider's office or a clinic can provide information on supplemental claims data. Facilities and pharmacies may also provide supplemental data. A provider or a designated office administrator can add the details of the supplemental claim for the patient by entering the relevant data on the system user interface. The data could also arrive from a health plan as a file over secured file transfer protocol, web service api, or EDI to the system server. This supplemental data, either it is entered by a provider into a user interface or has arrived from health plan partner is then processed and is loaded into the system's central data repository.

This supplemental data S for Patient p is known to have same key attributes {a1,a2,a3, . . . , an} for all Health plan payers.

The system is able to detect duplicate supplemental data entry, either in error or as potential fraud, not only for one specific Health Plan partner, but across various health plans.

If for patient P Health Plan H_{A} is observed to have provided supplemental data claim S_{PA} for date d, and at a later point Health Plan H_{B} is observed enter supplemental claim S_{PB} for same date d where

Key attributes of S_{PA}=Key attributes of S_{PB},

Then the system rejects inclusion of S_{PB} and notifies Health Plan H_{B} its ground for rejection of such and optionally reports the incident to Health Plan H_{A}.

Certain embodiments create ‘Rolling’ ‘Actionable’ versions of annual metrics. In such embodiments, metrics may be defined by third party standards. Standard health metrics like the ones by NQF, NCQA, PQA, CMS are defined over calendar years. At the middle of a calendar year, therefore, an observer [provider, health plan] can only view metrics scores over various diseases only till end of the previous year. The provider is not given a view on the current performance and thereby no means to realize any action that may help improve his/her performance on metrics for the current year until the point current year draws a close.

The system disclosed herein, by making the measurement year a rolling window, helps a provider with the following guiding information, that s/he may take into view to take proactive actions to improve performance.

Features of certain embodiments of the system that enable “rolling” or “actionable” versions of annual measures include:
Numerator [compliance], denominator [eligibility] as on end of each financial quarters and not just end of last calendar year. For example, if a provider wanted to observe his performance at the end of second quarter of current year, he could readily do so by choosing the quarter from a metrics drop-down menu.
A provider may look forward into future state of metrics by measurement year, by sliding forward the measurement window. In so doing, a provider could view the future values of metrics in the next quarter
By looking forward and then tracking back identify recoverable and non-recoverable non-compliance. For example, for metric M a patient is required to take n occurrences of different medical tests and procedures by date d and by regulation there must be an interval t days between two such procedures, in order for the patient to be compliant. By checking, if n*t<(d−current date) or n*t>=(d−current date), we will be able to tell that if all rules are followed patient is not going to be compliant on metrics M on a given future date d in the former case, whereas s/he may be so if s/he followed the remaining n procedures by then. By applying rolling windows for measurement period, together with future looking, we can always back-track such performance real time.

In the definition of the metrics there is a notion of measurement year. The metrics computation engine that resides on the database layer of the architecture and is implemented using stored procedure, this measurement year is passed as a variable parameter, while rest of the definition and mechanism for computing the specific metric remain unaltered. By changing the start date and end date of the metrics, different views or values of compliance, are provided and eligibility and exclusion figures over different periods of time.

Another embodiment of the system includes a “freeze metrics” feature. For a current period of measurement a provider, office administrator or provider support can view not only the aggregate compliant, eligible and excluded patients for different disease metrics, but can also view in detail the nature of compliance or non-compliance and the detail of the patients falling under the specific metrics along with his/her longitudinal medical history. He can also add supplemental data to augment a patient's medical history. In certain embodiments, this is not true for past quarters. The detailed view is frozen as soon as the calendar period is over. The provider can no longer view the previous quarter's detailed results, nor can he add or delete any data for that past period. However, he can continue to do so for the current period.

In a certain embodiment, this function resides in a drop-down menu on a user interface.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A method for determining a performance metric of a healthcare provider comprising the steps of:
obtaining a patient panel of a provider;
establishing inclusion criteria;
establishing exclusion criteria;
establishing compliance criteria;
setting a number of patients in the panel meeting the inclusion criteria as a denominator;
determining a number of patients who satisfy the inclusion criteria and also satisfy the compliance criteria;
setting a number of patients satisfying the compliance criteria in the numerator;
calculating a compliance ratio from the numerator and denominator; and
displaying the compliance ratio on an electronic device.

2. The method for determining a performance metric of a healthcare provider of claim 1 wherein a patient panel is obtained electronically.

3. The method for determining a performance metric of a healthcare provider of claim 1 wherein the number of patients who satisfy the compliance criteria is determined by obtaining information from an electronic health record.
